(19) United States
(12) Patent Application Publication
(10) Pub. No.: US 2021/0320544 A1
(43) Pub. Date: Oct. 14, 2021

(54) COOLING DEVICE FOR ON-VEHICLE ROTATING ELECTRICAL MACHINE

(71) Applicant: TOYOTA JIDOSHA KABUSHIKI KAISHA, Toyota-shi (JP)

(72) Inventors: Yukinori MURAKAMI, Toyota-shi (JP); Ryosuke SHIBATA, Nagoya-shi (JP)

(73) Assignee: TOYOTA JIDOSHA KABUSHIKI KAISHA, Toyota-shi (JP)

(21) Appl. No.: 17/203,822

(22) Filed: Mar. 17, 2021

(30) Foreign Application Priority Data
Apr. 8, 2020 (JP) 2020-070077

(51) Int. Cl. H02K 1/32; H02K 9/19; H02K 1/20

(52) U.S. Cl. CPC H02K 1/32; H02K 1/20; H02K 9/19

(57) ABSTRACT

A second wire harness passing under a cooling pipe is restricted by a restricting member to a position outside a plane that passes through a cooling oil hole and is perpendicular to a longitudinal direction of the cooling pipe. Thus, it is possible to prevent cooling oil released through the cooling oil hole from splashing onto the second wire harness, without having to dispose the second wire harness above the cooling pipe. As the cooling oil released through the cooling oil hole is efficiently supplied to a first rotating electrical machine, the performance of cooling the first rotating electrical machine is enhanced.

### CROSS-REFERENCE TO RELATED APPLICATION

This application claims priority to Japanese Patent Application No. 2020-070077 filed on Apr. 8, 2020, incorporated herein by reference in its entirety.

### BACKGROUND

### 1. Technical Field

The present disclosure relates to a cooling device for an on-vehicle rotating electrical machine that is installed in a vehicle, and more particularly to a cooling device having a structure of cooling an on-vehicle rotating electrical machine by cooling oil released from a cooling pipe that is disposed above the on-vehicle rotating electrical machine.

### 2. Description of Related Art

There has been a proposed structure in which a cooling pipe parallel to a rotational axis of an on-vehicle rotating electrical machine (hereinafter referred to as the rotating electrical machine) installed in a vehicle is disposed above the rotating electrical machine and cooling oil is released from this cooling pipe toward a stator and a rotor constituting parts of the rotating electrical machine to thereby cool the rotating electrical machine. That is the rotating electrical machine cooling structure of Japanese Patent Application Publication No. 2019-75859 (JP 2019-75859 A). In JP 2019-75859 A, two cooling pipes having different supply sources are disposed above a rotating electrical machine and cooling oil is stably supplied to the rotating electrical machine to enhance the performance of cooling the rotating electrical machine.

### SUMMARY

A stator constituting a part of a rotating electrical machine is commonly connected to a power control unit (PCU) located outside a case through a wire harness (WH). If cooling oil splashes onto the wire harness, the cooling efficiency of the rotor and the stator will decrease. A conceivable countermeasure is to dispose the wire harness so as to pass above the cooling pipe. However, as the size of the case housing the rotating electrical machine is reduced, the distances among the stator, the cooling pipe, and the case are reduced accordingly, which makes it difficult to dispose the wire harness so as to pass above the cooling pipe. This problem concerns not only the wire harness connected to the stator but also cables housed inside the case; when these cables need to be passed under the cooling pipe, the performance of cooling the rotor and the stator may decrease if cooling oil released from the cooling pipe splashes onto the cables.

The present disclosure has been contrived in view of the above situation, and an object thereof is to provide a structure that is applied to a cooling device for an on-vehicle rotating electrical machine having a structure of cooling an on-vehicle rotating electrical machine by a cooling fluid released from a cooling pipe disposed above the on-vehicle rotating electrical machine, and that can prevent the cooling fluid from splashing onto a cable passing under the cooling pipe.

The gist of a first aspect is as follows: (a) A cooling device for an on-vehicle rotating electrical machine that is used for an on-vehicle rotating electrical machine including a stator and a rotor housed inside a case as components, the cooling device including a cooling pipe that has an elongated shape and is disposed above the stator and the rotor in a vertical direction in a vehicle-mounted state and disposed along a rotational axis of the rotor, a cooling fluid supplied to the cooling pipe being released onto at least one of the stator and the rotor through a cooling fluid release hole formed in the cooling pipe, wherein (b) the cooling pipe is provided with a restricting member that restricts a relative position in a longitudinal direction of the cooling pipe, relative to the cooling pipe, of a cable passing under the cooling pipe to a position outside a plane that passes through the cooling fluid release hole and is perpendicular to the longitudinal direction.

The gist of a second aspect is that, in the cooling device for an on-vehicle rotating electrical machine of the first aspect, the restricting member is an L-shaped member that is provided at a position outside the plane passing through the cooling fluid release hole and perpendicular to the longitudinal direction of the cooling pipe and anchors the cable.

In the cooling device for an on-vehicle rotating electrical machine of the first aspect, the cable passing under the cooling pipe is restricted by the restricting member to a position outside the plane passing through the cooling fluid release hole and perpendicular to the longitudinal direction of the cooling pipe. Thus, it is possible to prevent the cooling fluid released through the cooling fluid release hole from splashing onto the cable, without having to dispose the cable above the cooling pipe. As the cooling fluid released through the cooling fluid release hole is efficiently supplied to the on-vehicle rotating electrical machine, the performance of cooling the on-vehicle rotating electrical machine is enhanced.

In the cooling device for an on-vehicle rotating electrical machine of the second aspect, the cable passing under the cooling pipe is anchored by the L-shaped member serving as the restricting member and hindered from moving to under the cooling fluid release hole. Thus, the cable is prevented from getting splashed with the cooling fluid.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a skeleton diagram schematically showing the configuration of a hybrid vehicle to which the present disclosure is applied;

FIG. 2 is a schematic view schematically showing a cooling device that cools a first rotating electrical machine;

FIG. 3 is a view showing the internal structure of a motor chamber in a power transmission device of FIG. 1;

FIG. 4 is an enlarged view showing a close-up of a structure above the first rotating electrical machine shown in FIG. 3; and

FIG. 5 is a perspective view illustrating the structure of a cooling pipe.

### DETAILED DESCRIPTION OF EMBODIMENTS

An embodiment of the present disclosure will be described in detail below with reference to the drawings. In the following embodiment, the drawings are simplified or modified as necessary and do not necessarily exactly represent the dimensional ratios, shapes, etc. of parts.

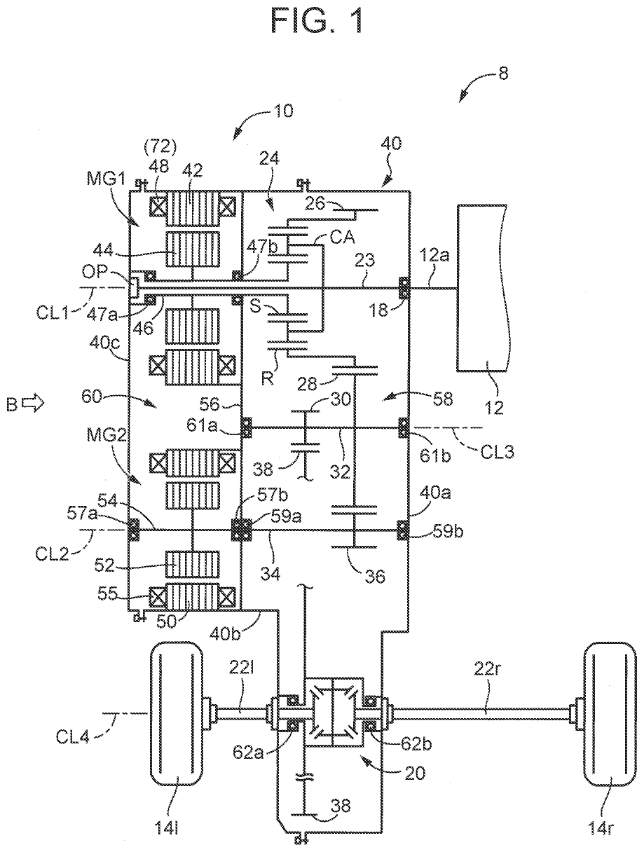

FIG. 1 is a skeleton diagram schematically showing the configuration of a hybrid vehicle 8 (hereinafter written as the vehicle 8) to which the present disclosure is applied. The vehicle 8 includes an on-vehicle power transmission device 10 (hereinafter written as the power transmission device 10) between an engine 12 and a pair of left and right driving wheels 14l, 14r (written as the driving wheels 14 when no distinction is made therebetween). The power transmission device 10 is suitably used for a front-engine, front-wheel-drive (FF) hybrid vehicle. The power transmission device 10 is a hybrid power transmission device that transmits, to the pair of left and right driving wheels 14l, 14r, power output from the engine 12 and a second rotating electrical machine MG2 that are travel driving force sources. The term “power” in this specification is synonymous with “torque” and “driving force.”

As shown in FIG. 1, the power transmission device 10 includes an input shaft 23, a planetary gear device 24, a first rotating electrical machine MG1, and an output gear 26 that are disposed so as to be rotatable around a first rotational axis CL1. The power transmission device 10 also includes a power transmission shaft 34, the second rotating electrical machine MG2, and a reduction gear 36 provided on the power transmission shaft 34 that are disposed so as to be rotatable around a second rotational axis CL2. The power transmission device 10 also includes a counter shaft 32, and a counter gear 28 and a differential drive gear 30 provided on the counter shaft 32, that are disposed so as to be rotatable around a third rotational axis CL3. The power transmission device 10 further includes a differential device 20 and axles 221, 22r that are disposed so as to be rotatable around a fourth rotational axis CL4. All these rotating members are housed inside a case 40 that is a non-rotating member. The first rotational axis CL1 to the fourth rotational axis CL4 are rotational axes that are disposed parallel to a vehicle width direction of the vehicle 8.

The first rotating electrical machine MG1 and the second rotating electrical machine MG2 are rotating electrical machines that function at least either as a motor to generate mechanical power from electrical energy or as a power generator to generate electrical energy from mechanical power, and are preferably motor-generators that can be selectively operated as a motor or a power generator. The first rotating electrical machine MG1 has a power generation (generator) function for receiving a reaction force of the engine 12 and a rotating electrical machine (motor) function of driving to rotate the engine 12 having been stopped. The second rotating electrical machine MG2 has a rotating electrical machine function for functioning as a rotating electrical machine for traveling that outputs a driving force as a driving force source for traveling, and a power generation function of generating electrical energy by regeneration from a reverse driving force transmitted from the driving wheels 14.

The input shaft 23 is coupled to the engine 12 through a crankshaft 12a of the engine 12 and a damper etc. (not shown) so as to be able to transmit power. The input shaft 23 is supported by the case 40 through a bearing 18 etc. so as to be rotatable around the first rotational axis CL1.

The planetary gear device 24 is disposed around the first rotational axis CL1 and formed by a single-pinion planetary gear device (differential mechanism) having a sun gear S, a carrier CA, and a ring gear R. The planetary gear device 24 functions as a power distribution mechanism that distributes power from the engine 12 to the first rotating electrical machine MG1 and the output gear 26. The sun gear S of the planetary gear device 24 is coupled to the first rotating electrical machine MG1 so as to be able to transmit power. The carrier CA is coupled to the engine 12 through the input shaft 23 and the crankshaft 12a so as to be able to transmit power. The ring gear R is coupled to the output gear 26 so as to be able to transmit power. The ring gear R and the output gear 26 are formed by a compound gear in which these gears are integrated.

In the direction of the first rotational axis CL1, the first rotating electrical machine MG1 is disposed at a position next to the planetary gear device 24 with a partition wall 56 that is a part of the case 40 interposed therebetween. The first rotating electrical machine MG1 includes a cylindrical stator 42 that is fixed to the case 40 so as not to be rotatable, a cylindrical rotor 44 that is disposed on an inner circumferential side of the stator 42, and a rotor shaft 46 that is coupled to an inner circumference of the rotor 44. A stator coil 48 is wound around the stator 42. The rotor shaft 46 is rotatably supported by the case 40 through a pair of bearings 47a, 47b disposed at both sides of the rotor shaft 46 in an axial direction thereof.

The output gear 26 is coupled to the ring gear R of the planetary gear device 24 and meshed with the counter gear 28 provided on the counter shaft 32.

The second rotating electrical machine MG2 and the reduction gear 36 are disposed so as to be rotatable around the second rotational axis CL2 and, in the direction of the second rotational axis CL2, disposed at positions next to each other with the partition wall 56 interposed therebetween. The second rotating electrical machine MG2 and the reduction gear 36 are connected to each other through the power transmission shaft 34 so as to be able to transmit power.

The second rotating electrical machine MG2 includes a cylindrical stator 50 that is fixed to the case 40 so as not to be rotatable, a cylindrical rotor 52 that is disposed on an inner circumferential side of the stator 50, and a rotor shaft 54 that is coupled to an inner circumference of the rotor 52. A stator coil 55 is wound around the stator 50. The rotor shaft 54 is rotatably supported by the case 40 through a pair of bearings 57a, 57b disposed at both sides of the rotor shaft 54 in an axial direction thereof.

The reduction gear 36 is integrally provided on the power transmission shaft 34 and meshed with the counter gear 28 provided on the counter shaft 32. As the number of teeth of the reduction gear 36 is set to be smaller than the number of teeth of the counter gear 28, rotation of the second rotating electrical machine MG2 is transmitted to the counter shaft 32 via the reduction gear 36 and the counter gear 28 while the speed thereof is reduced. The power transmission shaft 34 is rotatably supported by the case 40 through a pair of bearings 59a, 59b disposed at both sides of the power transmission shaft 34 in an axial direction thereof.

The counter shaft 32 is rotatably supported by the case 40 through a pair of bearings 61a, 61b disposed at both sides of the counter shaft 32 in an axial direction thereof.

The counter gear 28 and the differential drive gear 30 are provided on the counter shaft 32 that rotates around the third rotational axis CL3, so as not to be rotatable relatively to the counter shaft 32. As the counter gear 28 is meshed with the output gear 26 and the reduction gear 36, power output from the engine 12 and the second rotating electrical machine MG2 is transmitted to the counter gear 28. The differential drive gear 30 is meshed with a differential driven gear 38 of the differential device 20. Thus, when power is transmitted to the counter gear 28 from at least one of the output gear 26 and the reduction gear 36, this power is transmitted to the differential device 20 via the counter shaft 32 and the differential drive gear 30.

The differential device 20 and the pair of left and right axles 221, 22r are disposed so as to be rotatable around the fourth rotational axis CL4. As the differential driven gear 38 of the differential device 20 meshes with the differential drive gear 30, power output from at least one of the engine 12 and the second rotating electrical machine MG2 is transmitted to the differential device 20 through the differential driven gear 38.

The differential device 20 is formed by a well-known differential mechanism and transmits power to the pair of left and right axles 221, 22r while allowing relative rotation of the pair of left and right axles 221, 22r. The differential device 20 is rotatably supported by the case 40 through a pair of bearings 62a, 62b disposed at both sides of the differential device 20 in the direction of the fourth rotational axis CL4. As the differential device 20 is a commonly known technology, the description thereof will be omitted.

The case 40 is composed of a first case member 40a, a second case member 40b, and a third case member 40c. The second case member 40b is open at both sides in the direction of the first rotational axis CL1, and the first case member 40a is fastened to one opening of the second case member 40b with bolts while the third case member 40c is fastened to the other opening of the second case member 40b with bolts.

The partition wall 56 perpendicular to the first rotational axis CL1 is formed inside the second case member 40b. The inside of the case 40 is divided by the partition wall 56 into a gear chamber 58 in which various gears including the planetary gear device 24, the output gear 26, the counter gear 28, the reduction gear 36, and the differential device 20 are housed, and a motor chamber 60 in which the first rotating electrical machine MG1 and the second rotating electrical machine MG2 are housed.

A mechanical oil pump OP driven by the engine 12 is provided on the first rotational axis CL1, at an end of the input shaft 23 on the opposite side from the engine 12 in an axial direction of the input shaft 23. A driving gear (not shown) that drives the oil pump OP is connected to a shaft end of the input shaft 23, and the oil pump OP is driven to rotate in conjunction with rotation of the engine 12. The oil pump OP is configured to pump oil stored in a lower part of the gear chamber 58.

In the power transmission device 10 configured as has been described above, power from the engine 12 is transmitted to the left and right driving wheels 14l, 14r through the planetary gear device 24, the output gear 26, the counter gear 28, the counter shaft 32, the differential drive gear 30, the differential device 20, and the axles 221, 22r. Power from the second rotating electrical machine MG2 is transmitted to the left and right driving wheels 14l, 14r through the rotor shaft 54, the power transmission shaft 34, the reduction gear 36, the counter gear 28, the counter shaft 32, the differential drive gear 30, the differential device 20, and the axles 221, 22r.

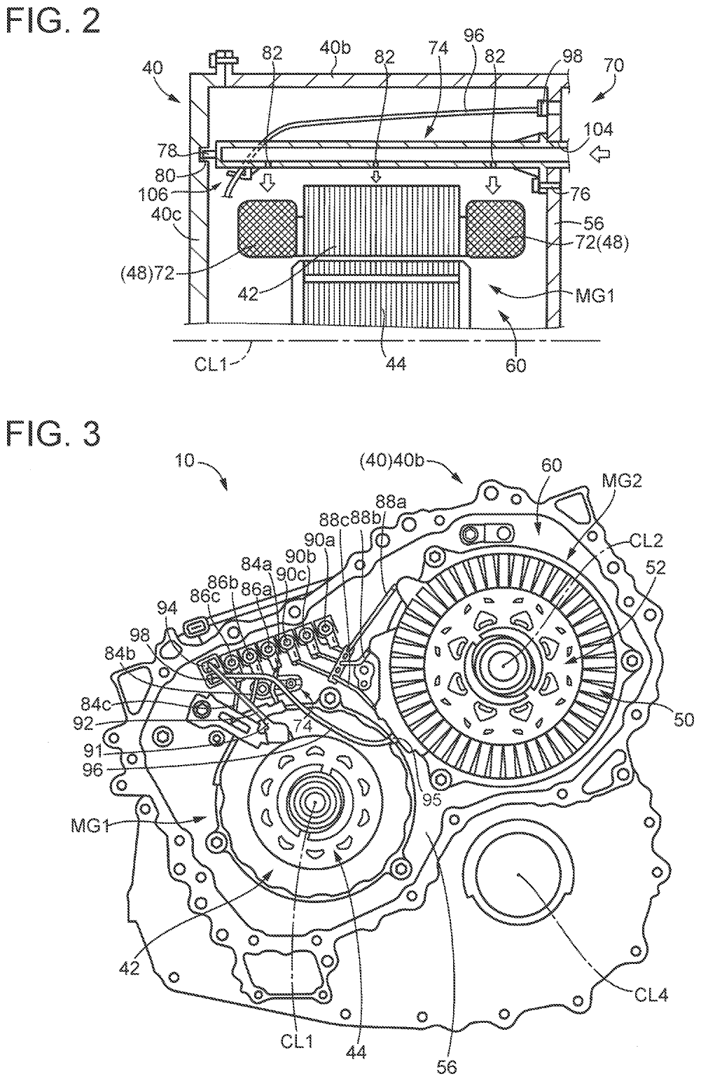

FIG. 2 is a schematic view schematically showing the structure of a cooling device 70 that cools the first rotating electrical machine MG1 The upper side in the sheet of FIG. 2 corresponds to the upper side in a vertical direction in a vehicle-mounted state. The first rotating electrical machine MG1 corresponds to the on-vehicle rotating electrical machine of the present disclosure.

In FIG. 2, part of the first rotating electrical machine MG1 housed in the motor chamber 60 formed inside the case 40 is shown in a sectional view. The first rotating electrical machine MG1 is disposed so as to be rotatable around the first rotational axis CL1. The first rotating electrical machine MG1 includes the cylindrical rotor 44 and the cylindrical stator 42 disposed on an outer circumferential side of the rotor 44. The stator 42 and the rotor 44 are each formed by a plurality of disc-shaped magnetic steel sheets that is stacked along the first rotational axis CL1.

A plurality of grooves formed parallel to the first rotational axis CL1 is formed in an inner circumferential part of the stator 42, and the stator coil 48 is wound so as to pass through these grooves. In this connection, a coil end 72 formed by a bundle of the stator coil 48 is disposed at each end of the stator 42 in the direction of the first rotational axis CL1. The stator 42 is configured to include the stator coil 48 wound around the stator 42.

When the first rotating electrical machine MG1 is driven, a current is applied to the stator coil 48 and heat is generated in the stator coil 48. The heat generated in the stator coil 48 is dissipated partly by being conducted to the stator 42. However, heat is hardly dissipated at the coil ends 72 that are not in contact with the stator 42. In the cooling device 70, as a countermeasure, a cooling pipe 74 is disposed above the first rotating electrical machine MG1 in the vertical direction in the vehicle-mounted state and cooling oil is released from the cooling pipe 74 toward the first rotating electrical machine MG1 to cool the first rotating electrical machine MG1. The cooling oil corresponds to the cooling fluid of the present disclosure.

The cooling device 70 includes the cooling pipe 74 disposed above the first rotating electrical machine MG1 in the vertical direction. The cooling pipe 74 is formed by a pipe-like member that is open at one end in a longitudinal direction thereof. The cooling pipe 74 is disposed parallel to the first rotational axis CL1 such that the longitudinal direction lies along the first rotational axis CL1. The cooling pipe 74 is fixed at one end in the longitudinal direction to the partition wall 56 of the second case member 40b with a bolt 76. At the other end of the cooling pipe 74 in the longitudinal direction, a projection 78 is formed, and as the projection 78 fits into a recess 80 formed in the third case member 40c, shaking of the cooling pipe 74 is mitigated.

The cooling oil is supplied to the cooling pipe 74 through an opening at one end in the longitudinal direction indicated by the arrow. For example, cooling oil pumped by the oil pump OP is supplied to the cooling pipe 74. The cooling pipe 74 has a plurality of cooling oil holes 82 that allows communication between the inside and outside of the pipe. In the longitudinal direction of the cooling pipe 74 (i.e., the direction of the first rotational axis CL1), the cooling oil holes 82 are respectively formed at the same positions as positions where the pair of coil ends 72 is disposed and a position where the stator 42 is disposed. Thus, in the longitudinal direction of the cooling pipe 74, the cooling oil holes 82 are respectively formed at positions coinciding with the pair of coil ends 72 and the stator 42 as seen from a radial direction centered on the first rotational axis CL1. In a circumferential direction of the cooling pipe 74, the cooling oil holes 82 are formed at positions on a lower side in the vertical direction, i.e., at positions facing the pair of coil ends 72 and the stator 42.

With the cooling oil holes 82 formed at the above-described positions in the cooling pipe 74, the cooling oil supplied to the cooling pipe 74 is released through the cooling oil holes 82 toward the pair of coil ends 72 and the stator 42 as indicated by the arrows, and the pair of coil ends 72 and the stator 42 are efficiently cooled. The cooling oil holes 82 correspond to the cooling fluid release hole of the present disclosure.

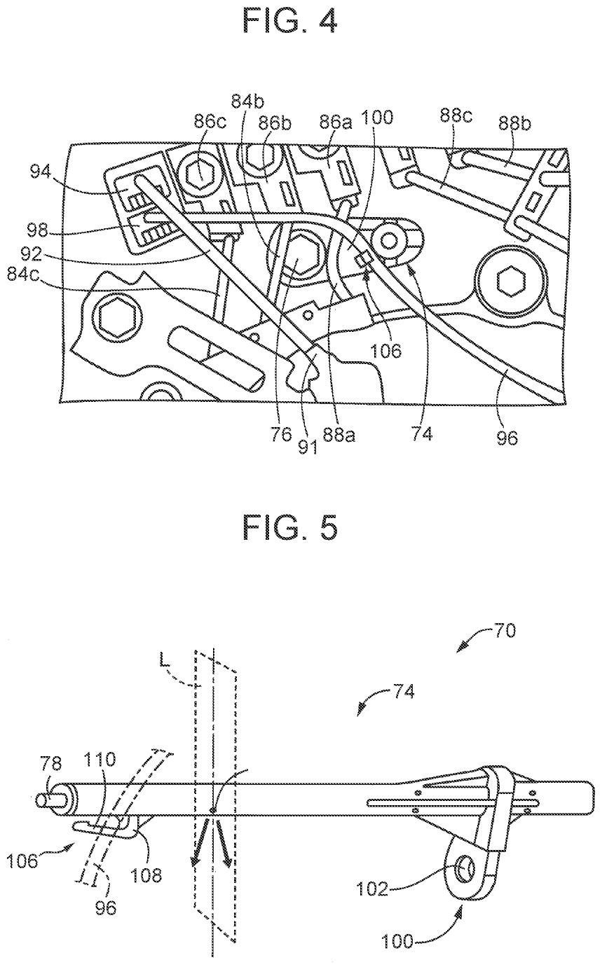

FIG. 3 is a view showing the internal structure of the motor chamber 60 in the power transmission device 10, and corresponds to FIG. 1 as seen from the direction of arrow B with the third case member 40c removed. The upper side in the sheet of FIG. 3 corresponds to the upper side in the vertical direction in the vehicle-mounted state, and the left side in the sheet corresponds to a forward travel direction. FIG. 4 is an enlarged view showing a close-up of a part above the first rotating electrical machine MG1 in FIG. 3.

As shown in FIG. 3, the first rotating electrical machine MG1 and the second rotating electrical machine MG2 are housed inside the motor chamber 60. The first rotating electrical machine MG1 is disposed so as to be rotatable around the first rotational axis CL1, and the second rotating electrical machine MG2 is disposed so as to be rotatable around the second rotational axis CL2. The first rotating electrical machine MG1 is disposed on a forward travel side in a vehicle travel direction relatively to the second rotating electrical machine MG2 and disposed below the second rotating electrical machine MG2 in the vertical direction.

The cooling pipe 74 that releases cooling oil for cooling the first rotating electrical machine MG1 is disposed above the first rotating electrical machine MG1 in the vertical direction in the vehicle-mounted state. The cooling pipe 74 is disposed on a front side in the vehicle travel direction relatively to the second rotating electrical machine MG2.

Three copper wires 84a to 84c respectively coupled to three-phase windings of the stator coil 48 extend from the stator 42 of the first rotating electrical machine MG1. The copper wires 84a to 84c are respectively connected to three-phase terminals 86a to 86c provided on the partition wall 56 of the second case member 40b.

Three copper wires 88a to 88c respectively coupled to three-phase windings of the stator coil 55 extend from the stator 50 of the second rotating electrical machine MG2. The copper wires 88a to 88c are respectively connected to three-phase terminals 90a to 90c provided on the partition wall 56 of the second case member 40b.

There is a first wire harness 92 extending to be connected to a sensor connector 91 of a temperature sensor provided on the stator 42 of the first rotating electrical machine MG1. The first wire harness 92 is connected at one end to the sensor connector 91 of the temperature sensor provided on the stator 42 and at the other end to a first connector 94 provided on the partition wall 56 of the second case member 40b.

There is a second wire harness 96 extending to be connected to a sensor connector 95 of a temperature sensor provided on the stator 50 of the second rotating electrical machine MG2. The second wire harness 96 is connected at one end to the sensor connector 95 of the temperature sensor provided on the stator 50 and at the other end to a second connector 98 provided on the partition wall 56 of the second case member 40b. The second wire harness 96 corresponds to the cable of the present disclosure.

The first connector 94 and the second connector 98 are provided near a wall of the second case member 40b that surrounds the first rotating electrical machine MG1 and the second rotating electrical machine MG2. The first connector 94 and the second connector 98 are disposed next to each other. Thus, terminals connected to the first connector 94 and the second connector 98 can be collected at one place. The first connector 94 and the second connector 98 are disposed above the cooling pipe 74 in the vertical direction in the vehicle-mounted state. The first connector 94 and the second connector 98 are disposed on the forward travel side in the vehicle travel direction relatively to the cooling pipe 74.

With the first connector 94 and the second connector 98 disposed at the above-described positions, the cooling pipe 74 is located between the second connector 98 and the second rotating electrical machine MG2 in the vehicle travel direction. This makes it necessary for the second wire harness 96 connecting the second connector 98 and the second rotating electrical machine MG2 to each other to pass above or under the cooling pipe 74. In this embodiment, due to restrictions on the layout inside the motor chamber 60 etc., the second wire harness 96 needs to be passed under the cooling pipe 74 as shown in FIG. 3.

Here, when the second wire harness 96 is passed under the cooling pipe 74, cooling oil released through the cooling oil holes 82 of the cooling pipe 74 may splash onto the second wire harness 96. Then, the required amount of cooling oil to cool the first rotating electrical machine MG1 will not be supplied to the first rotating electrical machine MG1, which may result in shortfall in the performance of cooling the first rotating electrical machine MG1. In addition, as the cooling oil having splashed onto the second wire harness 96 moves along the second wire harness 96 to the sensor connector 95 of the temperature sensor of the second rotating electrical machine MG2 or the second connector 98, foreign matter contained in the cooling oil may adhere to these connectors.

In this embodiment, as a countermeasure, the position at which the second wire harness 96 passes under the cooling pipe 74 is restricted such that the second wire harness 96 does not pass under the cooling oil holes 82 of the cooling pipe 74 in the vertical direction. Thus, the second wire harness 96 is prevented from getting splashed with the cooling oil.

FIG. 5 is a perspective view illustrating the structure of the cooling pipe 74. As shown in FIG. 5, the cooling pipe 74 is formed by a pipe-like member extending in the longitudinal direction. The right side in the sheet of FIG. 5 corresponds to a portion that is fixed to the partition wall 56 of the second case member 40b with the bolt 76. The left side in the sheet corresponds to a portion that is fitted into the recess 80 (see FIG. 1) formed in the third case member 40c.

As shown in FIG. 5, a collar 100 extending radially outward is formed on the side of the cooling pipe 74 in the longitudinal direction (the right side in the sheet of FIG. 5) that is fixed to the partition wall 56. The collar 100 has a bolt hole 102 through which the bolt 76 for fixing the cooling pipe 74 is passed. As one end of the cooling pipe 74 on the side fixed to the partition wall 56 is inserted through a through-hole 104 (see FIG. 2) of the partition wall 56 and in this state fastened with the bolt 76, the cooling pipe 74 is fixed to the partition wall 56. The cooling oil is supplied into the cooling pipe 74 through the opening formed on the side of the cooling pipe 74 in the longitudinal direction that is fixed to the partition wall 56.

The projection 78 protruding in the longitudinal direction is formed at the end of the cooling pipe 74 on the opposite side in the longitudinal direction from the side fixed to the partition wall 56 (on the left side in the sheet of FIG. 5). When the third case member 40c is installed, the projection 78 is fitted into the recess 80 formed in the third case member 40c, so that shaking of the cooling pipe 74 while the vehicle is traveling is mitigated.

The cooling pipe 74 has the cooling oil holes 82 that allow communication between the inside and outside of the pipe, and the cooling oil is released through the cooling oil holes 82 as indicated by the arrows. A restricting member 106 that restricts relative movement of the second wire harness 96 in the longitudinal direction relative to the cooling pipe 74 is provided at a position different from the positions where the cooling oil holes 82 are formed in the longitudinal direction of the cooling pipe 74, i.e., a position outside a plane L (see FIG. 5) that passes through the cooling oil hole 82 and is perpendicular to the longitudinal direction of the cooling pipe 74.

The restricting member 106 is formed in an L-shape composed of a short side 108 and a long side 110. The short side 108 is formed so as to protrude from the cooling pipe 74 in a direction perpendicular to the longitudinal direction of the cooling pipe 74 (i.e., toward a radially outer side). The long side 110 extends from a leading end of the short side 108 along the longitudinal direction of the cooling pipe 74 toward the projection 78, i.e., toward a side away from the cooling oil hole 82. A leading end of the long side 110 is inclined in a direction toward the cooling pipe 74, and the dimension of a gap left between the leading end of the long side 110 and the cooling pipe 74 is set to be smaller than the diameter of the second wire harness 96. Thus, when the second wire harness 96 is inserted into the gap between the long side 110 and the cooling pipe 74, the second wire harness 96 is hindered from dropping through the gap.

A portion of the second wire harness 96 that passes under the cooling pipe 74 is anchored by the restricting member 106. In FIG. 5, the long dashed short dashed line corresponds to the second wire harness 96. As shown in FIG. 5, the second wire harness 96 passing under the cooling pipe 74 is fixed by being held in a gap left between the cooling pipe 74 and the long side 110 of the restricting member 106.

This configuration can restrict relative movement in the longitudinal direction, relative to the cooling pipe 74, of the second wire harness 96 passing under the cooling pipe 74. For example, when the second wire harness 96 moves relatively to the cooling pipe 74 toward the cooling oil holes 82 in the longitudinal direction, the second wire harness 96 hits the short side 108 of the restricting member 106. Thus, relative movement of the second wire harness 96 toward the cooling oil holes 82 in the longitudinal direction relative to the cooling pipe 74 is restricted. In this way, the portion of the second wire harness 96 that passes under the cooling pipe 74 is restricted to a position offset from the cooling oil holes 82 in the longitudinal direction of the cooling pipe 74. In other words, the portion of the second wire harness 96 that passes under the cooling pipe 74 is restricted by the restricting member 106 to a position in the longitudinal direction of the cooling pipe 74 that is outside the plane L (see FIG. 5) passing through the cooling oil hole 82 and perpendicular to the longitudinal direction of the cooling pipe 74.

As the portion of the second wire harness 96 that passes under the cooling pipe 74 is thus restricted to a position offset from the cooling oil holes 82 in the longitudinal direction of the cooling pipe 74, the cooling oil released through the cooling oil holes 82 is prevented from splashing onto the second wire harness 96. As a result, the required amount of cooling oil to cool the first rotating electrical machine MG1 spreads throughout the first rotating electrical machine MG1 and the performance of cooling the first rotating electrical machine MG1 is enhanced. Moreover, adhesion of foreign matter to the connectors resulting from the cooling oil moving along the second wire harness 96 to the connectors is prevented. In addition, relative movement of the second wire harness 96 in the longitudinal direction relative to the cooling pipe 74 is restricted even when vibration of the traveling vehicle is transmitted to the second wire harness 96.

As has been described above, in this embodiment, the second wire harness 96 passing under the cooling pipe 74 is restricted by the restricting member 106 to a position outside the plane L that passes through the cooling oil hole 82 and is perpendicular to the longitudinal direction of the cooling pipe 74. Thus, it is possible to prevent the cooling oil released through the cooling oil hole 82 from splashing onto the second wire harness 96, without having to dispose the second wire harness 96 above the cooling pipe 74. As the cooling oil released through the cooling oil hole 82 is efficiently supplied to the first rotating electrical machine MG1, the performance of cooling the first rotating electrical machine MG1 is enhanced.

In this embodiment, the second wire harness 96 passing under the cooling pipe 74 is anchored by the L-shaped restricting member 106, so that the second wire harness 96 is hindered from moving to under the cooling oil hole 82. Thus, the second wire harness 96 is prevented from getting splashed with the cooling oil.

While the embodiment of the present disclosure has been described above in detail based on the drawings, the present disclosure can also be implemented with other aspects.

For example, in the above-described embodiment, the second wire harness 96 connecting the sensor connector 95 of the temperature sensor that detects the temperature of the second rotating electrical machine MG2 and the second connector 98 to each other passes under the cooling pipe 74 in the vertical direction, and the relative position of the second wire harness 96 in the longitudinal direction relative to the cooling pipe 74 is restricted by the restricting member 106. However, the cable of the present disclosure is not necessarily limited to the second wire harness 96. For example, the cable may be a wire harness that connects a resolver that detects the rotation speed of the second rotating electrical machine MG2 and a connector to each other. In short, the present disclosure can be appropriately used for any cable that needs to be passed under the cooling pipe 74.

The cooling pipe 74 is disposed such that the longitudinal direction lies parallel to the first rotational axis CL1. However, the arrangement of the cooling pipe 74 in the present disclosure is not necessarily limited to this parallel arrangement but can be appropriately changed within such a range that the longitudinal direction of the cooling pipe 74 lies along the first rotational axis CL1.

In the above-described embodiment, the cooling pipe 74 is fixed to the partition wall 56 of the second case member 40b with the bolt 76, but the cooling pipe 74 may instead be fixed to a wall of the third case member 40c with the bolt 76.

In the above-described embodiment, the first rotating electrical machine MG1 is an inner-rotor rotating electrical machine in which the rotor 44 is disposed on the inner circumferential side of the stator 42. However, the first rotating electrical machine MG1 may instead be an outer-rotor rotating electrical machine in which a rotor is disposed on an outer circumferential side of a stator. In this case, cooling oil is supplied exclusively to the rotor.

In the above-described embodiment, the restricting member 106 is formed by the L-shaped member composed of the short side 108 and the long side 110, but the restricting member 106 of the present disclosure is not necessarily limited to an L-shaped member. Any member can be appropriately adopted that has a structure that allows it to anchor the second wire harness 96, for example, a circular or elliptical member having a notch formed at a part in the circumferential direction through which the second wire harness 96 is inserted.

In the above-described embodiment, the first rotating electrical machine MG1 is cooled by cooling oil released through the cooling oil holes 82 of the cooling pipe 74. However, the cooling fluid of the present disclosure is not necessarily limited to cooling oil. Any fluid (cooling fluid) that can cool the first rotating electrical machine MG1 can be appropriately adopted.

What has been described above is merely one embodiment, and the present disclosure can be implemented with the aspects modified or improved in various ways based on the knowledge of those skilled in the art.

What is claimed is:

1. A cooling device for an on-vehicle rotating electrical machine that is used for an on-vehicle rotating electrical machine including a stator and a rotor housed inside a case as components, the cooling device comprising a cooling pipe that has an elongated shape and is disposed above the stator and the rotor in a vertical direction in a vehicle-mounted state and disposed along a rotational axis of the rotor, a cooling fluid supplied to the cooling pipe being released onto at least one of the stator and the rotor through a cooling fluid release hole formed in the cooling pipe, wherein the cooling pipe is provided with a restricting member that restricts a relative position in a longitudinal direction of the cooling pipe, relative to the cooling pipe, of a cable passing under the cooling pipe to a position outside a plane that passes through the cooling fluid release hole and is perpendicular to the longitudinal direction.

2. The cooling device for an on-vehicle rotating electrical machine according to claim 1, wherein the restricting member is an L-shaped member that is provided at a position outside the plane passing through the cooling fluid release hole and perpendicular to the longitudinal direction of the cooling pipe and anchors the cable.
